(19) United States
(12) Patent Application Publication
(10) Pub. No.: US 2023/0214019 A1
(43) Pub. Date: Jul. 6, 2023

(54) PROVIDING HAPTIC FEEDBACK BASED ON CONTENT ANALYTICS

(71) Applicant: International Business Machines Corporation, Armonk, NY (US)

(72) Inventors: Sri Harsha Varada, Vizianagaram (IN); Kiran Mantri, Visakhapatnam (IN); Saraswathi Sailaja Perumalla, Visakhapatnam (IN); Prerna Agarwal, New Delhi (IN)

(21) Appl. No.: 17/567,429

(22) Filed: Jan. 3, 2022

(51) Int. Cl. G06F 3/01; G06N 20/00

(52) U.S. Cl. CPC G06F 3/016; G06N 20/00

(57) ABSTRACT

A computer system provides haptic feedback based on content analytics. Media data is analyzed using a machine learning model to identify one or more moods for one or more portions of the media data. A haptic feedback response is determined based on the identified one or more moods. Instructions are provided to a haptic feedback device to cause the haptic feedback device to apply the haptic feedback response to a user in synchronization with presentation of the media data to the user. Embodiments of the present invention further include a method and program product for providing haptic feedback based on content analytics in substantially the same manner described above.

### BACKGROUND

### 1. Technical Field

Present invention embodiments relate to haptic technology, and more specifically, to providing haptic feedback based on content analytics obtained by processing media content.

### 2. Discussion of the Related Art

In the field of haptic technology, also known as kinesthetic communication, an experience of touch is created by applying various forces, such as vibrations, that are felt by a user. Haptic feedback refers to the use of haptic technology to present information to a user. For example, an interactive cinema may vibrate the seats during a film scene depicting a rocket launch or car race. However, conventional forms of haptic feedback fail to provide a satisfying level of immersion by omitting ranges of experience beyond the immediate, mechanical action of a scene.

### SUMMARY

According to one embodiment of the present invention, a computer system provides haptic feedback based on content analytics. Media data is analyzed using a machine learning model to identify one or more moods for one or more portions of the media data. A haptic feedback response is determined based on the identified one or more moods. Instructions are provided to a haptic feedback device to cause the haptic feedback device to apply the haptic feedback response to a user in synchronization with presentation of the media data to the user. Embodiments of the present invention further include a method and program product for providing haptic feedback based on content analytics in substantially the same manner described above.

### BRIEF DESCRIPTION OF THE DRAWINGS

Generally, like reference numerals in the various figures are utilized to designate like components.

FIG. 1 is a block diagram depicting a computing environment for providing haptic feedback based on content analytics in accordance with an embodiment of the present invention;

FIG. 2 is a diagram depicting a haptic feedback device in accordance with an embodiment of the present invention;

FIG. 3 is a diagram depicting a haptic feedback environment in accordance with an embodiment of the present invention;

FIG. 4 is a flow chart depicting a method of providing haptic feedback based on content analytics in accordance with an embodiment of the present invention;

FIG. 5 is a flow chart depicting a method of training and applying a machine learning model in accordance with an embodiment of the present invention; and

FIG. 6 is a block diagram depicting a computing device in accordance with an embodiment of the present invention.

### DETAILED DESCRIPTION

Present invention embodiments relate to haptic feedback, and more specifically, to providing haptic feedback based on content analytics obtained by processing media content. Haptic feedback can augment other media content, such as audio, video, and/or text, by providing a sense of touch to a user, thereby increasing the user's immersion. Haptic feedback can be applied in different forms, such as force (e.g., applying a pressure), vibrotactile (e.g., applying a vibration effect), electrotactile (e.g., electrical stimulation), ultrasound (e.g., applying pulsed ultrasonic waves), and thermal feedback (e.g., applying hot or cold air).

Typically, haptic feedback is provided along with media to enhance the experience of a scene. For example, when a scene in a film shows windy weather, haptic feedback might be provided by applying a jet of air to a viewer to simulate the wind. Thus, conventional forms of haptic feedback provide input to a user that simulates physical activity of a scene. In contrast, present invention embodiments provide haptic feedback to achieve the result of imparting a particular emotion or mood to a user.

Thus, instead of merely mimicking physical phenomena, present invention embodiments can also influence the emotional state of a viewer. In particular, present invention embodiments utilize machine learning to process media, such as video, audio, and/or text data, to identify moods in the media. A knowledge base that contains mappings of moods to particular forms of haptic feedback can be consulted, and haptic feedback can be provided to a user during presentation of the media to adjust the mood of the user throughout the media. For example, rapidly stimulating a portion of the user's arm can convey a mood such as apprehension or fear, whereas a calm and consistent application of pressure to a user's hand can convey a calm mood.

Thus, the embodiments presented herein improve the field of haptic technology by providing forms of haptic feedback that can impart various moods on a user. One or more machine learning models can be employed to process media to derive content analytics that can be used to select particular moods for particular portions of media, and a haptic feedback device can apply haptic feedback that corresponds to those moods in synchronization with playback of the media. Moreover, a machine learning model can be updated over time based on user feedback that is collected in order to continuously improve the accuracy of mood identification and/or relationships between moods and particular haptic feedback. Accordingly, present invention embodiments provide the practical application of providing mood-related haptic feedback based on content analytics in a manner that utilizes machine learning to increasingly improve the accuracy of the haptic feedback.

It should be noted that references throughout this specification to features, advantages, or similar language herein do not imply that all of the features and advantages that may be realized with the embodiments disclosed herein should be, or are in, any single embodiment of the invention. Rather, language referring to the features and advantages is understood to mean that a specific feature, advantage, or characteristic described in connection with an embodiment is included in at least one embodiment of the present invention. Thus, discussion of the features, advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages will become more fully apparent from the following drawings, description and appended claims, or may be learned by the practice of embodiments of the invention as set forth hereinafter.

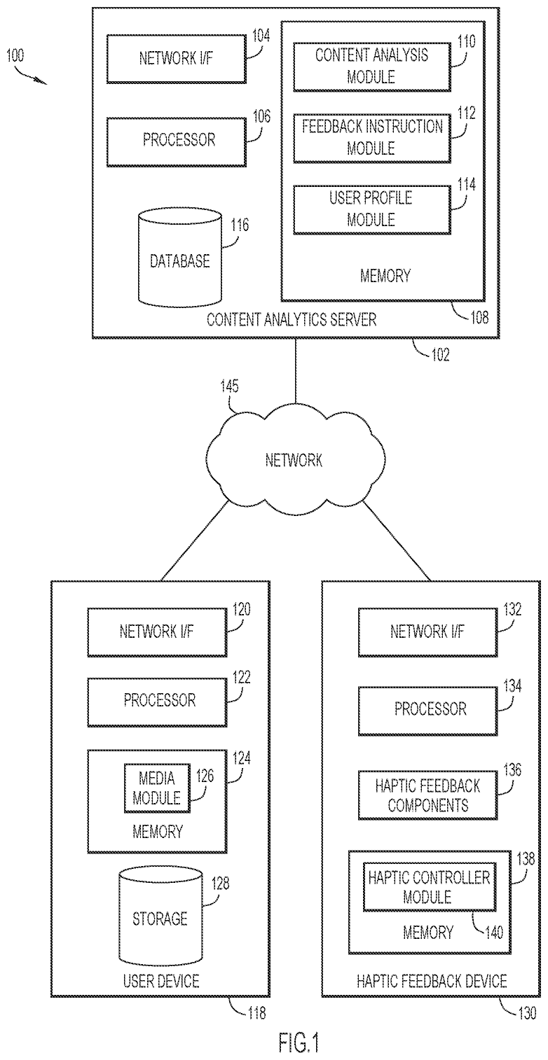

Present invention embodiments will now be described in detail with reference to the Figures. FIG. 1 is a block diagram depicting a computing environment 100 for providing haptic feedback based on content analytics in accordance with an embodiment of the present invention. As depicted, computing environment 100 includes a content analytics server 102, a user device 118, a haptic feedback device 130, and a network 145. It is to be understood that the functional division among components of computing environment 100 have been chosen for purposes of explaining present invention embodiments and is not to be construed as a limiting example.

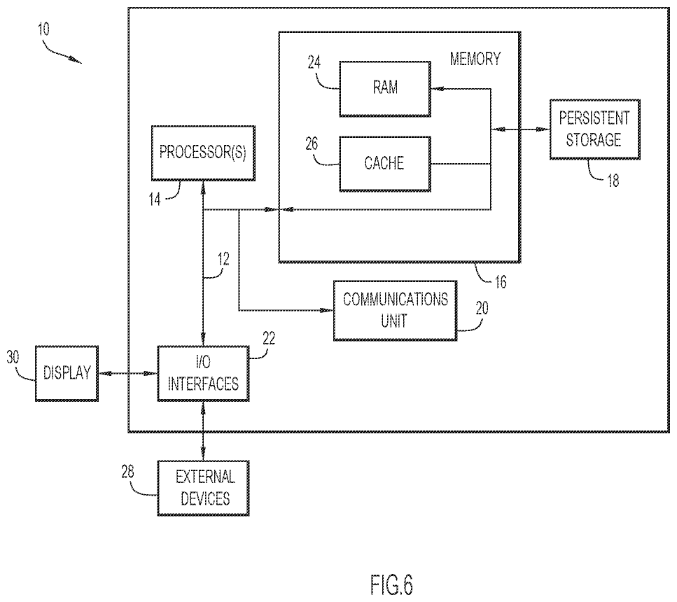

Content analytics server 102 includes a network interface (I/F) 104, at least one processor 106, memory 108, and a database 116. Memory 108 includes a content analysis module 110, a feedback instruction module 112, and a user profile module 114. Content analytics server 102 may include a laptop computer, a tablet computer, a netbook computer, a personal computer (PC), a desktop computer, a personal digital assistant (PDA), a smart phone, a thin client, a rack-mounted server, or any programmable electronic device capable of executing computer readable program instructions. Network interface 104 enables components of content analytics server 102 to send and receive data over a network, such as network 145. In general, content analytics server 102 may analyze media content to generate content analytics relating to identified moods and/or other features in the media content, and may generate haptic feedback instructions based on the content analytics. Content analytics server 102 may include internal and external hardware components, as depicted and described in further detail with respect to FIG. 6.

Content analysis module 110, feedback instruction module 112, and user profile module 114 may include one or more modules or units to perform various functions of present invention embodiments described below. Content analysis module 110, feedback instruction module 112, and user profile module 114 may be implemented by any combination of any quantity of software and/or hardware modules or units, and may reside within memory 108 of content analytics server 102 for execution by a processor, such as processor 106.

Content analysis module 110 may receive media and apply one or more machine learning models to the media to generate content analytics relating to moods and/or other features that are depicted, described, or otherwise conveyed in the media. The media may be obtained from a user device, such as user device 118, or may be obtained from any other network-accessible location, such as a third-party media server (e.g., a streaming service, a media repository, etc.). Additionally or alternatively, media may be stored in database 116 of content analytics server 102. The media may include video, audio, and/or text-based media. The media may be presentable to a user at a particular rate (e.g., a playback speed). In the case of text-based media, the text can be presented to a user by auto-scrolling the text across a user interface, or the user can define the presentation rate (e.g., by manually scrolling through pages or based on the user's gaze as determined by eye-tracking techniques). Accordingly, the media can be presented in a time-series manner at a particular playback rate, and thus, the media can be divided into portions that correspond to, for example, different scenes, chapters, etc.

Content analysis module 110 may train and/or apply one or more machine learning models to process media in order to perform mood classification for portions of the media. In some embodiments, a machine learning model is trained using a set of training data containing examples of media that are labeled with the features that are desired to be indicated by the content analytics, such as a mood depicted by the media. For example, video, audio, and/or text samples can be provided with mood labels, such as an exciting mood, a joyful mood, a fearful mood, a sad mood, an angry mood, an analytical mood, a confident mood, and a tentative mood. In various embodiments, samples of labeled data for any desired mood or combination of moods can be provided. Once trained, the machine learning model can accordingly output content analytics that classify input media with respect to moods.

In various embodiments, the type of machine learning model may include a logistic regression model, a random forest model, a support vector machine model, a neural network model (e.g., a convolutional neural network model, a recurrent neural network model, etc.), or any other model that can support present invention embodiments. The machine learning model may be retrained based on user feedback, thereby refining the model to improve how accurately moods are detected in media. For example, users can provide feedback to indicate whether the moods identified by the content analytics for particular scenes were accurate or inaccurate, and the model can be retrained, using the feedback, to increase the accuracy of the model over time. The resulting content analytics that are output by a trained model may be provided to feedback instruction module 112 to select haptic feedback instructions based on the content analytics.

Feedback instruction module 112 may generate haptic feedback instructions that correspond to a particular sequence of media data; the haptic feedback instructions can be executed by a haptic feedback device to provide haptic feedback in synchronization with playback of the media to a user. Feedback instruction module 112 can maintain a knowledge base of mappings of particular moods (e.g., that are indicated by the content analytics) to particular haptic feedback instructions. The instructions may include a location to provide the haptic feedback (e.g., a location on the user), a strength of feedback (e.g., weak, medium, strong), a speed of feedback pulses (e.g., slow, medium, fast), a range of feedback (e.g., short range, moderate range, wide range, etc.), a particular pattern to apply pulses of haptic feedback, and the like. For example, an exciting mood may be mapped to instructions that provide a strong, short-range haptic feedback to the thumb, a strong, short-range haptic feedback to the index finger, and a strong, short-range haptic feedback to the center of the hand. As another example, a sad mood may be mapped to instructions that provide medium-range, slow pulses of haptic feedback to the outer palm of a user, and/or strong, moderate-range haptic feedback to the user's pinky finger. Accordingly, the haptic feedback instructions can cause any combination of haptic feedback to be applied to a user by specifying combinations of location, strength, pulse pattern, and/or range of the feedback.

In some embodiments, the mappings between particular moods and particular haptic feedback instructions are predefined mappings. In some embodiments, feedback instruction module 112 updates the mappings of the knowledge base over time based on user feedback. In particular, a user may specify portions of the media content during which the user preferred or did not prefer the haptic feedback, and the knowledge base can be updated to remove or minimize usage of undesired haptic feedback and/or increase the usage of desired haptic feedback. In some embodiments, the mappings are determined according to a machine learning model that can update the mappings over time based on the user feedback. The machine learning model may be an artificial neural network model, such as a recurrent neural network or a convolutional neural network, that can be initially provided with predefined mappings and continuously retrained using user feedback. Accordingly, present invention embodiments may adjust the type of haptic feedback that is selected and applied for a particular mood over time. In some embodiments, the mappings between particular moods and particular haptic feedback instructions can additionally depend on a user's preferences.

User profile module 114 receives and stores user preferences that can be used by feedback instruction module 112 to select the particular haptic feedback instructions that are provided to a haptic feedback device of a particular user. A user can define any haptic feedback that they do not wish to receive based on the particular instructions or combinations of instructions (e.g., location, strength, pulse pattern, and/or range of the feedback). For example, a user can indicate a preference to not receive any strong haptic feedback, or to not receive any haptic feedback to their palm, etc. In some embodiments, a user can provide a list of only the haptic feedback types that the user desires to experience. In some embodiments, a user may indicate that the user prefers not to receive any haptic feedback for certain moods, or a user may indicate that haptic feedback for certain moods should be overridden with a user-defined feedback. In some embodiments, a user can indicate any disabilities, such as vision disabilities, and feedback instruction module 112 can use this information to modify the haptic feedback provided to the user. For example, additional haptic feedback may be provided to a user who has difficulty seeing during a windy scene of a film to enhance the user's experience. Additionally or alternatively, a user's preferences may indicate a region of the user, and feedback instruction module 112 can modify the haptic feedback provided to the user in content that is foreign to the user. For example, when there is an emotionally-moving scene in a foreign film, a user may be provided with stronger haptic feedback.

Database 116 may include any non-volatile storage media known in the art. For example, database 116 can be implemented with a tape library, optical library, one or more independent hard disk drives, or multiple hard disk drives in a redundant array of independent disks (RAID). Similarly, data in database 116 may conform to any suitable storage architecture known in the art, such as a file, a relational database, an object-oriented database, and/or one or more tables. In some embodiments, database 116 may store data including media data, content analytics, a knowledge base of mappings of moods to haptic feedback instructions, user profile data, and any other data in accordance with present invention embodiments.

User device 118 includes a network interface (I/F) 120, at least one processor 122, memory 124, and storage 128. Memory 124 includes a media module 126. User device 118 may include a laptop computer, a tablet computer, a netbook computer, a personal computer (PC), a desktop computer, a personal digital assistant (PDA), a smart phone, a thin client, or any programmable electronic device capable of executing computer readable program instructions. Network interface 120 enables components of user device 118 to send and receive data over a network, such as network 145. In general, user device 118 presents media to a user, including video, audio, and/or text-based media. User device 118 may include internal and external hardware components, as depicted and described in further detail with respect to FIG. 6.

Media module 126 may include one or more modules or units to perform various functions of present invention embodiments described below. Media module 126 may be implemented by any combination of any quantity of software and/or hardware modules or units, and may reside within memory 124 of user device 118 for execution by a processor, such as processor 122.

Media module 126 may present media to a user, including any video, audio, and/or text-based media. Accordingly, media module 126 may include any features necessary to enable playback of media, including drivers, codecs, and the like, and may integrate with one or more displays, speakers, and the like. Media module 126 may communicate with haptic feedback device 130 by indicating a current playback location of the media so that haptic feedback device 130 can synchronize haptic feedback with playback of the media.

Storage 128 may include any non-volatile storage media known in the art. For example, storage 128 can be implemented with a tape library, optical library, one or more independent hard disk drives, or multiple hard disk drives in a redundant array of independent disks (RAID). Similarly, data in storage 128 may conform to any suitable storage architecture known in the art, such as a file, a relational database, an object-oriented database, and/or one or more tables. In some embodiments, storage 128 may store data corresponding to video, audio, and/or text. As a non-exhaustive example, storage 128 may store media comprising films, videos, television shows, audiobooks, podcasts, novels, documentaries, music, and the like.

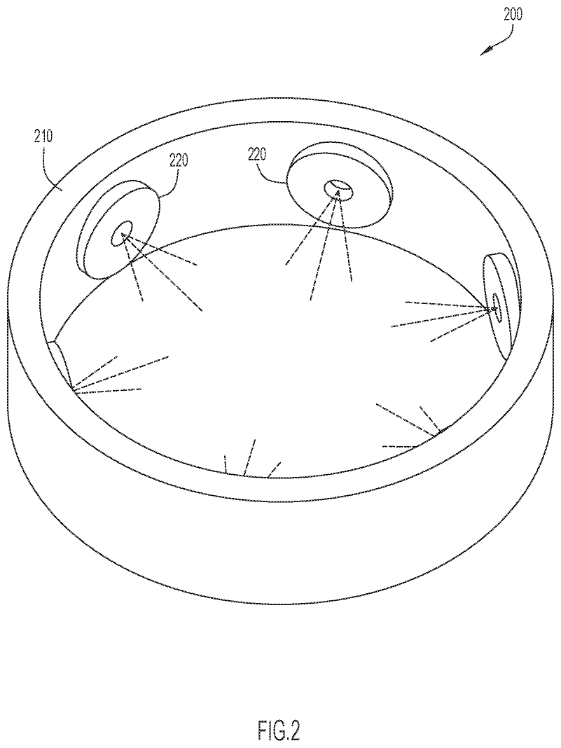

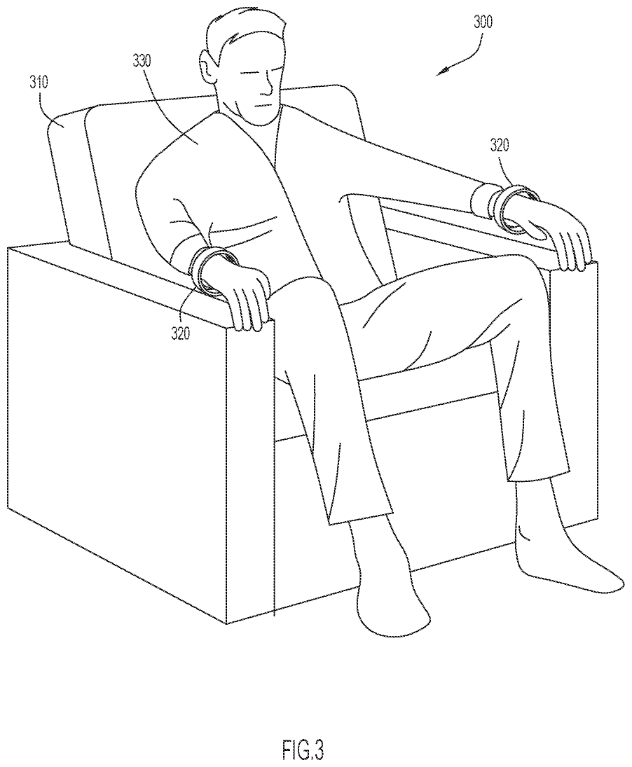

Haptic feedback device 130 includes a network interface (I/F) 132, at least one processor 134, haptic feedback components 136, and memory 138, which includes a haptic controller module 140. Haptic feedback device 130 may include any device capable of receiving haptic feedback instructions and executing the haptic feedback instructions to cause haptic feedback device 130 to provide haptic feedback to a user. Network interface 132 enables components of haptic feedback device 130 to send and receive data over a network, such as network 145. Haptic feedback device 130 may include internal and external hardware components, as depicted and described in further detail with respect to FIGS. 2, 3, and/or 6.

Haptic feedback components 136 may include components that apply haptic feedback to a user. At least a portion of haptic feedback components 136 may make direct or indirect contact with one or more locations on a user's body to provide the haptic feedback. The haptic feedback may be force feedback, vibrotactile feedback, electrotactile feedback, ultrasound feedback, and/or thermal feedback. In some embodiments the haptic feedback components 136 apply a puff or stream of a pressurized fluid to a user, such as pressurized air. The pressurized air may be provided by selectively opening one or more valves to permit air to escape from a pressurized air source. In some embodiments, the pressurized air is provided using a fan or air pump. Haptic feedback components 136 may be situated to provide haptic feedback to a specific portion of a user's body, such as the user's arms, legs, hands, wrists, fingers, palms, and the like.

Haptic controller module 140 may control haptic feedback components by executing the haptic feedback instructions to cause haptic feedback to be applied to a user. Haptic controller module 140 may receive the haptic feedback instructions for a particular media sequence from content analytics server 102, and may synchronize with media module 126 of user device 118 to execute the haptic feedback instructions as the media is presented to a user. In some embodiments, haptic controller module 140 temporarily suspends execution of the haptic feedback instructions in response to receiving a notification from user device 118 that the user has paused playback of media. Similarly, haptic feedback instructions may be provided with spans of time to which the various instructions apply so that when a user selects any point in time of the playback of a media sequence, the corresponding haptic feedback instructions can be executed.

Network 145 may include a local area network (LAN), a wide area network (WAN) such as the Internet, or a combination of the two, and includes wired, wireless, or fiber optic connections. In general, network 145 can be any combination of connections and protocols known in the art that will support communications between content analytics server 102, user device 118, and/or haptic feedback device 130 via their respective network interfaces in accordance with embodiments of the present invention.

FIG. 2 is a diagram depicting a haptic feedback device 200 in accordance with an embodiment of the present invention. As depicted, haptic feedback device 200 includes a body 210 and a plurality of haptic feedback components 220. In the depicted embodiment, the haptic feedback components 220 are emitting pressurized air; each haptic feedback component 220 may be selectively controlled to provide different forms of haptic feedback at different times. In some embodiments, the body 210 of haptic feedback device 200 can be worn around a user's hand or wrist, and the haptic feedback components 220 may thus selectively apply haptic feedback to a user's hand (including center of palm, edges of palm, and/or specific fingers) or wrist.

FIG. 3 is a diagram depicting a haptic feedback environment 300 in accordance with an embodiment of the present invention. As depicted, environment 300 includes a chair 310 and two haptic feedback devices 320 worn by a user 330. The user 330 may sit in chair 310 to be presented with media from a playback device such as a television or cinema screen. During playback of the media sequence, the user may rest the user's hands or wrists, upon which are worn haptic feedback devices 320, on arms of the chair 310 in order to receive haptic feedback that is synchronized with the media, in accordance with present invention embodiments. In the depicted embodiment, haptic feedback devices 320 are not physically connected to chair 310; in various other embodiments, haptic feedback devices 320 and chair 310 may form an assembly in which one or more haptic feedback devices 320 are associated with chair 310.

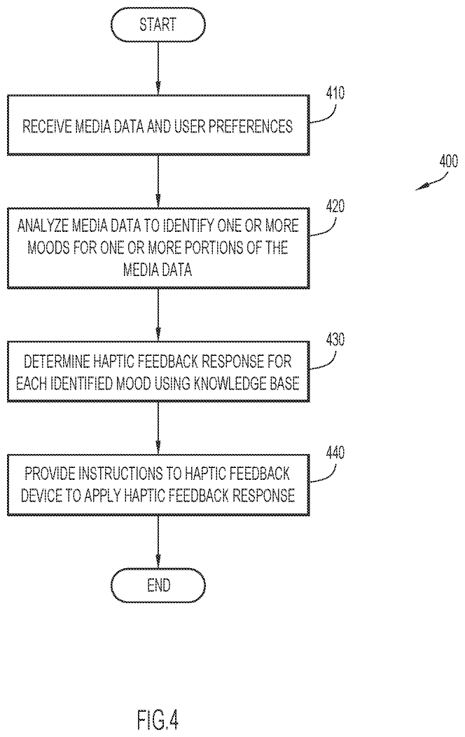

FIG. 4 is a flow chart depicting a method 400 of providing haptic feedback based on content analytics in accordance with an embodiment of the present invention.

Media data and user preferences are received at operation 410. Content analytics server 102 may receive user preferences from user device 118. The media data may be stored locally (e.g., in database 116 of content analytics server 102), may be received from user device 118, may be obtained from another network-accessible location, such as a third-party streaming service. In some embodiments, the media includes video media that is presented to a user via a smart contact lens that projects the video content to the user's eye, and the media can be obtained from the contact lens or from the of the media for the contact lens.

The media data is analyzed to identify one or more moods for one or more portions of the media data at operation 420. A trained machine learning model may be applied to process the media data to generate content analytics that indicate one or more moods for various portions of the media data. In some embodiments, a content timeline is generated that lists spans of time of media playback and corresponding moods for each span of time. For example, the ten minute mark to the twelve minute mark of a film might be labeled with a “sad” mood, and the like. In some embodiments, a same portion of media data can be labeled with multiple moods, such as exciting and confident. In some embodiments, the machine learning model identifies moods including an exciting mood, a joyful mood, a fearful mood, a sad mood, an angry mood, an analytical mood, a confident mood, a tentative mood, and/or other moods. Moods can be identified by performing tone analysis on text, which can be extracted from audio data using conventional or other voice-to-text conversion techniques. For video data, moods may be identified based on content in each frame, which can be identified using image processing techniques that perform object recognition (e.g., the machine learning model can be trained to associate certain objects with certain moods).

A haptic feedback response for each identified mood is determined using a knowledge base at operation 430. The knowledge base may include mappings of particular moods to particular haptic feedback responses. In some embodiments, the haptic feedback is presented by directing pressurized streams, pulses, etc., of air onto a user's body. The particular haptic feedback response for a given mood can be defined in the knowledge base by providing a particular combination of settings, including a location of the feedback on the user's person, a strength of the feedback, a pulse pattern of the feedback, and/or a range of the feedback. In some embodiments, different responses for a same mood can be provided at different points in time during media playback to introduce a variety in different scenes. For example, there may be two or more haptic feedback responses mapped to a “sad” mood, and they may be selected randomly or in another fashion for a given scene. In some embodiments, the received user preferences are used to modify the haptic feedback responses that are selected for particular users.

Instructions are provided to the haptic feedback device to apply the haptic feedback response at operation 440. Content analytics server 102 provides the instructions to haptic feedback device 130 to cause the device to apply the haptic feedback to a user. The haptic feedback may be synchronized with playback of the media by communicating with user device 118 to enable the correct haptic feedback instructions to be executed at the appropriate times.

In some embodiments, the determination of moods and haptic feedback responses may be performed a priori by processing a media sequence. In other embodiments, the determination of moods and haptic feedback responses may be performed in real-time or near-real-time while media is being streamed to a user.

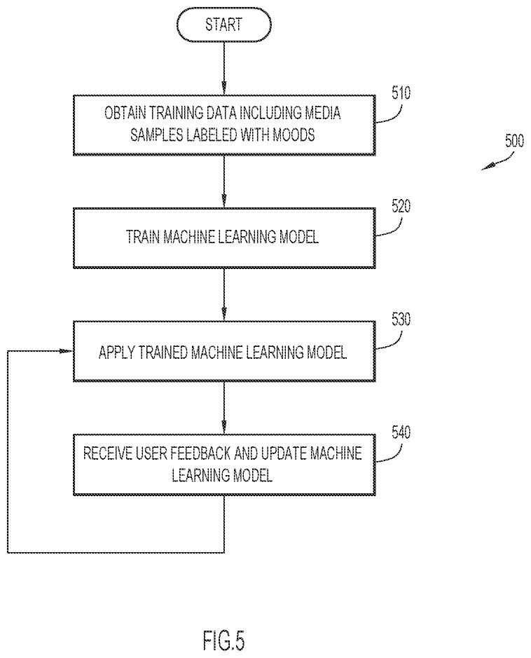

FIG. 5 is a flow chart depicting a method 500 of training and applying a machine learning model in accordance with an embodiment of the present invention.

Training data including media samples labeled with moods is obtained at operation 510. The training data may include media samples, such as video, audio, and/or text-based media, that are labeled with desired moods, such as an exciting mood, a joyful mood, a fearful mood, a sad mood, an angry mood, an analytical mood, a confident mood, a tentative mood, and/or other moods.

A machine learning model is trained at operation 520. The machine learning model may undergo training using the training data until the machine learning model can accurately identify moods beyond a threshold level, which can be confirmed using a set of testing data that can be extracted from the larger set of training data. In some embodiments, different models may be developed for each of video, audio, and text-based media. In some embodiments, a single machine learning model may be trained to process any type of input media (e.g., using multi-task learning or other techniques).

The trained machine learning model is applied at operation 530. The machine learning model may be applied to identify moods in media before or during presentation of the media to a user. The identified moods can be used to consult a knowledge base of haptic feedback instructions that can be executed to apply haptic feedback to a user.

User feedback is received and the machine learning model is updated accordingly at operation 540. One or more users can indicate, for each portion of a media sequence, whether the haptic feedback was desired or undesired. Accordingly, the machine learning model can be re-trained to update the model, and applied again at operation 530 to more accurately identify moods in media content.

FIG. 6 is a block diagram depicting components of a computer 10 suitable for executing the methods disclosed herein. Computer 10 may implement content analytics server 102, user device 118, and/or haptic feedback device 130 in accordance with embodiments of the present invention. It should be appreciated that FIG. 6 provides only an illustration of one embodiment and does not imply any limitations with regard to the environments in which different embodiments may be implemented. Many modifications to the depicted environment may be made.

As depicted, the computer 10 includes communications fabric 12, which provides communications between computer processor(s) 14, memory 16, persistent storage 18, communications unit 20, and input/output (I/O) interface(s) 22. Communications fabric 12 can be implemented with any architecture designed for passing data and/or control information between processors (such as microprocessors, communications and network processors, etc.), system memory, peripheral devices, and any other hardware components within a system. For example, communications fabric 12 can be implemented with one or more buses.

Memory 16 and persistent storage 18 are computer readable storage media. In the depicted embodiment, memory 16 includes random access memory (RAM) 24 and cache memory 26. In general, memory 16 can include any suitable volatile or non-volatile computer readable storage media.

One or more programs may be stored in persistent storage 18 for execution by one or more of the respective computer processors 14 via one or more memories of memory 16. The persistent storage 18 may be a magnetic hard disk drive, a solid state hard drive, a semiconductor storage device, read-only memory (ROM), erasable programmable read-only memory (EPROM), flash memory, or any other computer readable storage media that is capable of storing program instructions or digital information.

The media used by persistent storage 18 may also be removable. For example, a removable hard drive may be used for persistent storage 18. Other examples include optical and magnetic disks, thumb drives, and smart cards that are inserted into a drive for transfer onto another computer readable storage medium that is also part of persistent storage 18.

Communications unit 20, in these examples, provides for communications with other data processing systems or devices. In these examples, communications unit 20 includes one or more network interface cards. Communications unit 20 may provide communications through the use of either or both physical and wireless communications links.

I/O interface(s) 22 allows for input and output of data with other devices that may be connected to computer 10. For example, I/O interface 22 may provide a connection to external devices 28 such as a keyboard, keypad, a touch screen, and/or some other suitable input device. External devices 28 can also include portable computer readable storage media such as, for example, thumb drives, portable optical or magnetic disks, and memory cards.

Software and data used to practice embodiments of the present invention can be stored on such portable computer readable storage media and can be loaded onto persistent storage 18 via I/O interface(s) 22. I/O interface(s) 22 may also connect to a display 30. Display 30 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Data relating to providing haptic feedback based on content analytics (e.g., media data, content analytics data, mappings of moods to haptic feedback instructions, user profile data, machine learning model data, etc.) may be stored within any conventional or other data structures (e.g., files, arrays, lists, stacks, queues, records, etc.) and may be stored in any desired storage unit (e.g., database, data or other repositories, queue, etc.). The data transmitted between content analytics server 102, user device 118, and/or haptic feedback device 130 may include any desired format and arrangement, and may include any quantity of any types of fields of any size to store the data. The definition and data model for any datasets may indicate the overall structure in any desired fashion (e.g., computer-related languages, graphical representation, listing, etc.).

Data relating to providing haptic feedback based on content analytics (e.g., media data, content analytics data, mappings of moods to haptic feedback instructions, user profile data, machine learning model data, etc.) may include any information provided to, or generated by, content analytics server 102, user device 118, and/or haptic feedback device 130. Data relating to providing haptic feedback based on content analytics may include any desired format and arrangement, and may include any quantity of any types of fields of any size to store any desired data. The data relating to providing haptic feedback based on content analytics may include any data collected about entities by any collection mechanism, any combination of collected information, and any information derived from analyzing collected information.

The present invention embodiments may employ any number of any type of user interface (e.g., Graphical User Interface (GUI), command-line, prompt, etc.) for obtaining or providing information (e.g., data relating to providing haptic feedback based on content analytics), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

It will be appreciated that the embodiments described above and illustrated in the drawings represent only a few of the many ways of providing haptic feedback based on content analytics.

The environment of the present invention embodiments may include any number of computer or other processing systems (e.g., client or end-user systems, server systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system (e.g., desktop, laptop, PDA, mobile devices, etc.), and may include any commercially available operating system and any combination of commercially available and custom software (e.g., communications software, server software, content analysis module 110, feedback instruction module 112, user profile module 114, media module 126, haptic controller module 140, etc.). These systems may include any types of monitors and input devices (e.g., keyboard, mouse, voice recognition, etc.) to enter and/or view information.

It is to be understood that the software (e.g., communications software, server software, content analysis module 110, feedback instruction module 112, user profile module 114, media module 126, haptic controller module 140, etc.) of the present invention embodiments may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client and server systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The software of the present invention embodiments (e.g., communications software, server software, content analysis module 110, feedback instruction module 112, user profile module 114, media module 126, haptic controller module 140, etc.) may be available on a non-transitory computer useable medium (e.g., magnetic or optical mediums, magneto-optic mediums, floppy diskettes, CD-ROM, DVD, memory devices, etc.) of a stationary or portable program product apparatus or device for use with stand-alone systems or systems connected by a network or other communications medium.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information (e.g., data relating to providing haptic feedback based on content analytics). The database system may be implemented by any number of any conventional or other databases, data stores or storage structures (e.g., files, databases, data structures, data or other repositories, etc.) to store information (e.g., data relating to providing haptic feedback based on content analytics). The database system may be included within or coupled to the server and/or client systems. The database systems and/or storage structures may be remote from or local to the computer or other processing systems, and may store any desired data (e.g., data relating to providing haptic feedback based on content analytics).

The present invention embodiments may employ any number of any type of user interface (e.g., Graphical User Interface (GUI), command-line, prompt, etc.) for obtaining or providing information (e.g., data relating to providing haptic feedback based on content analytics), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The present invention embodiments are not limited to the specific tasks or algorithms described above, but may be utilized for any number of applications in the relevant fields, including, but not limited to, identifying any features in media data and applying haptic feedback to a user based on those features.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer-implemented method for providing haptic feedback based on content analytics, the method comprising:
analyzing media data using a machine learning model to identify one or more moods for one or more portions of the media data, wherein analyzing the media data includes performing image processing to recognize an object in a video portion of the media data;
determining a haptic feedback response based on the identified one or more moods, wherein a plurality of different haptic feedback responses are mapped to the identified one or more moods, and wherein the haptic feedback response is randomly selected from the plurality of different haptic feedback responses; and
providing instructions to a haptic feedback device to cause the haptic feedback device to apply the haptic feedback response to a user in synchronization with presentation of the media data to the user.

2. The computer-implemented method of claim 1, further comprising:
training the machine learning model to analyze input media to perform mood classification, wherein the machine learning model is updated based on user feedback.

3. The computer-implemented method of claim 1, wherein the haptic feedback response is determined according to a knowledge base that includes mappings of particular moods to particular haptic feedback responses.

4. The computer-implemented method of claim 1, wherein the haptic feedback response includes an application of a pressurized fluid.

5. The computer-implemented method of claim 4, wherein the pressurized fluid is air, and wherein the air is applied to a hand of the user.

6. The computer-implemented method of claim 1, wherein the media data includes one or more from a group of: video data, audio data, and text data.

7. The computer-implemented method of claim 1, wherein the one or more moods are selected from a group of: an exciting mood, a joyful mood, a fearful mood, a sad mood, an angry mood, an analytical mood, a confident mood, and a tentative mood.

8. The computer-implemented method of claim 1, further comprising:
receiving user preferences for haptic feedback; and
wherein the haptic feedback response is further determined based on the user preferences.

9. A computer system for providing haptic feedback based on content analytics, the computer system comprising:
one or more computer processors;
one or more computer readable storage media;
program instructions stored on the one or more computer readable storage media for execution by at least one of the one or more computer processors, the program instructions comprising instructions to:
analyze media data using a machine learning model to identify one or more moods for one or more portions of the media data, wherein analyzing the media data includes performing image processing to recognize an object in a video portion of the media data;
determine a haptic feedback response based on the identified one or more moods, wherein a plurality of different haptic feedback responses are mapped to the identified one or more moods, and wherein the haptic feedback response is randomly selected from the plurality of different haptic feedback responses; and
provide instructions to a haptic feedback device to cause the haptic feedback device to apply the haptic feedback response to a user in synchronization with presentation of the media data to the user.

10. The computer system of claim 9, wherein the program instructions further comprise instructions to:
train the machine learning model to analyze input media to perform mood classification, wherein the machine learning model is updated based on user feedback.

11. The computer system of claim 9, wherein the haptic feedback response is determined according to a knowledge base that includes mappings of particular moods to particular haptic feedback responses.

12. The computer system of claim 9, wherein the haptic feedback response includes an application of a pressurized fluid.

13. The computer system of claim 12, wherein the pressurized fluid is air, and wherein the air is applied to a hand of the user.

14. The computer system of claim 9, wherein the media data includes one or more from a group of: video data, audio data, and text data.

15. The computer system of claim 9, wherein the one or more moods are selected from a group of: an exciting mood, a joyful mood, a fearful mood, a sad mood, an angry mood, an analytical mood, a confident mood, and a tentative mood.

16. The computer system of claim 9, wherein the program instructions further comprise instructions to:
receive user preferences for haptic feedback; and
wherein the haptic feedback response is further determined based on the user preferences.

17. A computer program product for providing haptic feedback based on content analytics, the computer program product comprising one or more computer readable storage media collectively having program instructions embodied therewith, the program instructions executable by a computer to cause the computer to:
analyze media data using a machine learning model to identify one or more moods for one or more portions of the media data, wherein analyzing the media data includes performing image processing to recognize an object in a video portion of the media data;
determine a haptic feedback response based on the identified one or more moods, wherein a plurality of different haptic feedback responses are mapped to the identified one or more moods, and wherein the haptic feedback response is randomly selected from the plurality of different haptic feedback responses; and
provide instructions to a haptic feedback device to cause the haptic feedback device to apply the haptic feedback response to a user in synchronization with presentation of the media data to the user.

18. The computer program product of claim 17, wherein the program instructions further cause the computer to:
train the machine learning model to analyze input media to perform mood classification, wherein the machine learning model is updated based on user feedback.

19. The computer program product of claim 17, wherein the haptic feedback response is determined according to a knowledge base that includes mappings of particular moods to particular haptic feedback responses.

20. The computer program product of claim 17, wherein the haptic feedback response includes an application of a pressurized fluid.
